(19) United States
(12) Patent Application Publication
(10) Pub. No.: US 2020/0023995 A1
(43) Pub. Date: Jan. 23, 2020

(54) UNMANNED AERIAL VEHICLE

(71) Applicant: SZ DJI TECHNOLOGY CO., LTD., Shenzhen (CN)

(72) Inventors: Liang SONG, Shenzhen (CN); Hongyun MA, Shenzhen (CN); Yazhen WEI, Shenzhen (CN)

(21) Appl. No.: 16/445,803

(22) Filed: Jun. 19, 2019

Related U.S. Application Data
(63) Continuation of application No. PCT/CN2016/112037, filed on Dec. 26, 2016.

(51) Int. Cl. B64D 47/08; B64C 39/02

(52) U.S. Cl. CPC B64D 47/08; B64C 2201/108; B64C 39/024

(57) ABSTRACT

An unmanned aerial vehicle (UAV) includes a fuselage and an object avoidance device connected to the fuselage. The object avoidance device includes an image sensor. An axis of the image sensor is oblique with respect to the fuselage.

### CROSS-REFERENCE TO RELATED APPLICATION

This application is a continuation application of International Application No. PCT/CN2016/112037, filed on Dec. 26, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to unmanned aerial vehicle (UAV) technology and, more particularly, to a UAV having an object avoidance device.

### BACKGROUND

Currently, many UAVs are equipped with a visually-guided object avoidance device. When a UAV is flying horizontally forward, the UAV tilts such that the nose of the UAV dips. A larger tilt angle of the UAV usually corresponds to a higher forward flight speed. When the tilt angle is too large (for example to generate high enough forward flight speed), an object in a flight path of the UAV may be outside a vertical field of view (FOV) of the object avoidance device. Therefore, the UAV may fail to detect and avoid the object.

### SUMMARY

In accordance with the disclosure, there is provided an unmanned aerial vehicle (UAV) including a fuselage and an object avoidance device connected to the fuselage. The object avoidance device includes an image sensor. An axis of the image sensor is oblique with respect to the fuselage.

Also in accordance with the disclosure, there is provided a UAV including a fuselage and an object avoidance device connected to the fuselage. The object avoidance device includes an image sensor. An axis of the image sensor is parallel to the fuselage, and a width dimension of the image sensor is smaller than a height dimension of the image sensor.

### BRIEF DESCRIPTION OF THE DRAWINGS

FIG. 1 is a top view of an unmanned aerial vehicle (UAV).

FIG. 2 is a side view of the UAV in FIG. 1.

FIG. 3 shows an object avoidance device of the UAV in FIG. 1.

FIG. 4 shows the UAV in FIG. 1 in a flight attitude.

FIG. 5 is a perspective view of a UVA according to an exemplary embodiment of the disclosure.

FIG. 6 is a side view of the UVA in FIG. 5.

FIG. 7 shows the UVA in FIG. 5 in a flight attitude.

FIG. 8 shows an object avoidance device according to an exemplary embodiment of the disclosure.

FIG. 9 shows an object avoidance device according to another exemplary embodiment of the disclosure.

FIGS. 10 to 12 show a UVA in the flight attitude according to an exemplary embodiment of the disclosure.

FIG. 13 shows a UVA in the flight attitude according to another exemplary embodiment of the disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Exemplary embodiments will be described with reference to the accompanying drawings, in which the same numbers refer to the same or similar elements unless otherwise specified.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

In the situation where the technical solutions described in the present disclosure are not conflicting, they can be combined.

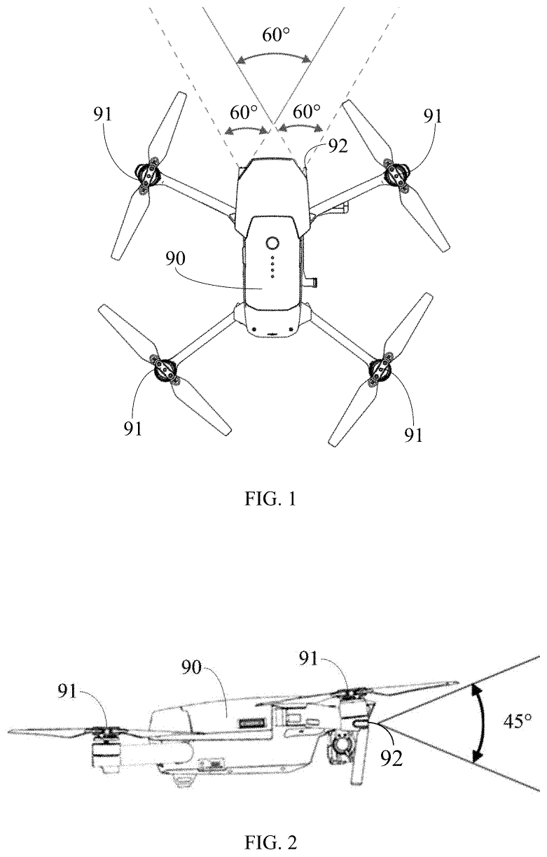

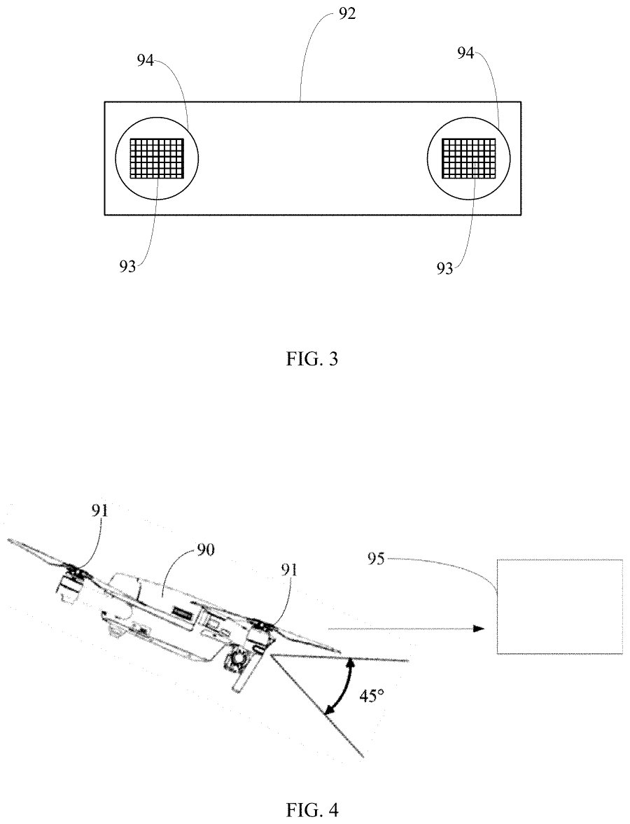

FIGS. 1 and 2 show an unmanned aerial vehicle (UAV), which includes a fuselage 90, propellers 91 provided on the fuselage 90, and an object avoidance device provided on a bracket 92. The bracket 92 is provided on a front end of the fuselage 90. FIG. 3 schematically shows the object avoidance device. As shown in FIG. 3, the object avoidance device includes two image sensors 93. The two image sensors 93 are provided inside two lenses 94, respectively. The two image sensors 93 are laterally spaced apart for a certain distance on the bracket 92 and are perpendicular to the fuselage 90.

Aspect ratios of both image sensors 93 of the object avoidance device are generally 4:3. Therefore, a horizontal detection angle, i.e., a horizontal field of view (FOV), can be larger than a vertical detection angle, i.e., a vertical FOV. The horizontal detection angle can be, for example, 60° as shown in FIG. 1 and the vertical detection angle can be, for example, 45° as shown in FIG. 2. That is, the horizontal FOV can be larger than the vertical FOV. The FOV of the UVA may be referred to as the FOV of the two image sensors 93 of the object avoidance device, or simply as the FOV of the object avoidance device. As shown in FIG. 4, for example, when the UAV is flying horizontally forward, the rotating speeds of two rear propellers 91 can be increased and the rotating speeds of two front propellers 91 can be decreased, such that the nose of the UAV can dip to allow the propellers 91 to produce a forward thrust in the horizontal direction to push the UAV to fly forward.

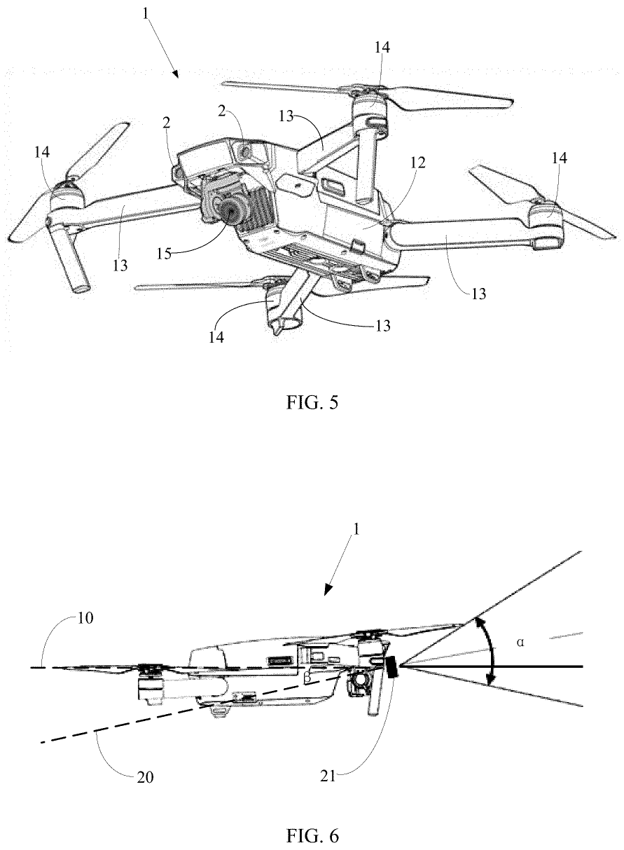

FIGS. 5 to 7 show a UAV 1 consistent with the present disclosure. The UAV 1 includes an object avoidance device 2, which includes an image sensor 21. As shown in FIG. 6, an axis 20 of the image sensor 21 is oblique with respect to a roll axis 10 of the UAV 1, for example, when the UAV 1 is in a horizontal attitude (when the UAV 1 is not tilted forward). That is, the image sensor 21 is arranged such that the axis 20 of the image senor 21 is oblique with respect to a fuselage 12 of the UAV 1. The axis 20 of the image sensor 21, as shown in, e.g., FIG. 6, can be perpendicular to a sensing surface of the image sensor 21. Hereinafter, unless otherwise specified, the description of the axis 20 being oblique with respect to the roll axis 10 refers to the axis 20 being oblique with respect to the roll axis 10 when the UAV 1 is in the horizontal attitude. Similarly, an angle between the axis 20 and the roll axis 10 refers to an angle between the axis 20 and the roll axis 10 when the UAV 1 is in the horizontal attitude. As such, even when a pitch angle of the UAV 1 is greater than or equal to a half of a FOV of the object avoidance device 2, the roll axis 10 can still be in the FOV of the object avoidance device 2. That is, the flight direction of the UAV 1 still falls in the FOV of the object avoidance device 2. As such, when the UAV 1 is in a flight attitude, the object avoidance device 2 of the UAV 1 can detect an object in front of the UAV 1, which allows the UAV 1 to fly at a relative large attitude angle. The safety of the UAV 1 can be improved. In some embodiments, when the UAV 1 is in a horizontal attitude, the fuselage 12 of the UAV 1 is parallel to the roll axis 10 of the UAV 1.

The roll axis may refer to an axis through the body of the UAV (tail and nose) and parallel to the horizontal plane, or an axis in the direction of flight and parallel to the horizontal plane.

According to the present disclosure, an inclination angle of the axis 20 of the image sensor 21 with respect to the roll axis 10 of the UAV 1 when the UAV is in the horizontal attitude can offset the pitch angle of the UAV 1 to a certain extent when the UAV 1 is flying forward, which increases a range of the FOV of the object avoidance device 2 when the UAV 1 is in the flight attitude. As such, when the UAV 1 is in the flight attitude, the object avoidance device 2 of the UAV 1 can detect an object in front of the UAV 1, which allows the UAV 1 to fly at a relative large attitude angle. The safety of the UAV 1 can be improved.

In some embodiments, as shown in FIG. 6, the FOV of the object avoidance device 2 includes a horizontal FOV and a vertical FOV a. When the pitch angle of the UAV 1 is greater than or equal to a half of the vertical FOV a, the roll axis can still fall in the FOV of the object avoidance device 2.

In some embodiments, as shown in FIGS. 5 and 8, the UAV 1 also includes a fuselage bracket 11. The object avoidance device 2 is provided on the fuselage bracket 11. The fuselage bracket 11 is provided on a front end of the UAV 1, such that when the UAV 1 is flying, the object avoidance device 2 can have a best FOV to improve the safety of the UAV 1. In some embodiments, the object avoidance device 2 includes a lens 22. The image sensor 21 is provided behind the lens 22.

In some embodiments, the UAV 1 includes two object avoidance devices 2 provided on two sides of the UAV 1, respectively. As such, the FOV of the object avoidance devices 2 can be further enlarged to improve the efficiency of object detection and the safety of the UAV 1.

In some embodiments, as shown in FIG. 5, the UAV 1 further includes the fuselage 12, and arms 13, propellers 14, and a camera 15 provided on the fuselage 12. In some embodiments, the UAV 1 may be a multi-rotor aircraft, such as a four-rotor aircraft, a six-rotor aircraft, or an eight-rotor aircraft.

In some embodiments, the image sensor 21 is provided on the front end of the UAV 1, such that when the UAV 1 is flying, the object avoidance device 2 can have the best FOV to improve the safety of the UAV 1. In some other embodiments, the image sensor 21 may be provided at a position slightly rotated toward two sides of the front end of the UAV 1, which can also offset the pitch angle of the UAV 1 to a certain degree when the UAV 1 is flying forward, and increase the range of the FOV of the object avoidance device 2 when the UAV 1 is in a flight attitude. As such, when the UAV 1 is in the flight attitude, the object avoidance device 2 of the UAV 1 can detect an object in front of the UAV 1, thereby allowing the UAV 1 to fly at a relative large attitude angle. The safety of the UAV 1 can be improved.

In some embodiments, as shown in FIG. 6, the axis 20 of the image sensor 21 is oblique with respect to the roll axis 10 of the UAV 1 at a predetermined angle. In some embodiments, an angle β between the axis 20 of the image sensor 21 and the roll axis 10 of the UAV 1 is an acute angle. In some embodiments, the angle β may be in the range of 1° to 20°. That is, an angle between the axis 20 of the image sensor 21 and the fuselage 12 of the UAV 1 is an acute angle, which can be in the range of 1° to 20°.

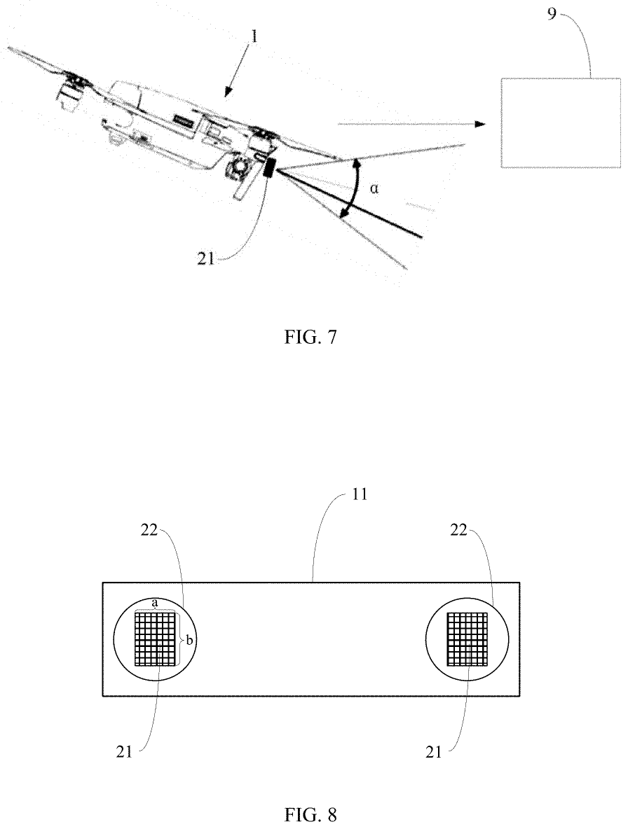

The operation principle of the object avoidance device 2 of the UAV 1 will be described below in connection with FIG. 7 and taking the angle β being 10° as an example. The image sensor 21 is provide in front of the UAV 1, and the axis 20 of the image sensor 21 is oblique with respect to the roll axis 10 of the UAV 1 at 10°. The UAV 1 has an original horizontal FOV of 60° and an original vertical FOV of 45°.

Because the image sensor 21 is obliquely arranged as described above, an upper portion of the vertical FOV (also referred to as an “upper vertical FOV”) above the fuselage 12 of the UAV 1 is increased to 32.5°, as compared to the upper vertical FOV of 22.5° in the scenario that the image sensor 21 is not obliquely arranged. As shown in FIG. 7, when the UAV 1 is flying, the UAV 1 is in a forward-tilting attitude. As long as the UAV 1 is horizontally flying at an attitude angle less than 32.5°, the object avoidance device 2 can effectively detect an object 9 in the direction of flight. That is, when the axis 20 of the image sensor 21 is oblique with respect to the roll axis 10 of the UAV 1 at 10°, the flying attitude angle of the UAV 1 can be increased by 10° from the original 22.5°. The speeds of the UAV 1 at different attitude angles are different. A larger attitude angle may correspond to a higher flight speed of the UAV. Therefore, the speeds corresponding to the attitude angles of 22.5° and 32.5° can be different.

Therefore, according to the present disclosure, an inclination angle of the axis 20 of the image sensor 21 with respect to the roll axis 10 of the UAV 1 when the UAV is in the horizontal attitude can offset the pitch angle of the UAV 1 to a certain extent when the UAV 1 is flying forward, which increases a range of the FOV of the object avoidance device 2 when the UAV 1 is in the flight attitude. As such, when the UAV 1 is in the flight attitude, the object avoidance device 2 of the UAV 1 can detect an object in front of the UAV 1, which allows the UAV 1 to fly at a relative large attitude angle. The safety of the UAV 1 can be improved. Further, since the FOV of the object avoidance device 2 is increased, the UAV 1 can fly at a larger attitude angle to improve the flight speed of the UAV 1.

In some embodiments, as shown in FIG. 8, a width dimension a of the image sensors 21 is smaller than a height dimension b. That is, the axis 20 of the image sensor 21 is oblique with respect to the roll axis 10 of the UAV 1 and the width dimension of the image sensor 21 is smaller than the height dimension of the image sensor 21, such that the FOV, e.g., the vertical FOV, of the object avoidance device 2 can be further expanded.

Referring again to FIG. 7, for example, the image sensor 21 is provide on the front of the UAV 1, and the axis 20 of the image sensor 21 tilts upward for 10° with respect to the roll axis 10 of the UAV 1. Further, the width dimension of the image sensor 21 is smaller than the height dimension of the image sensor 21.

Assume that for a UAV including an image sensor having a width dimension larger than a height dimension (such as shown in FIG. 3), the original horizontal FOV is 60° and the original vertical FOV is 45°, then for the image sensor 21 shown in FIG. 8 that has the width dimension smaller than the height dimension, the vertical FOV becomes 60°. In this scenario, when the UAV 1 is horizontally flying at an attitude angle less than 30°, the object avoidance device 2 can effectively detect the object 9 in the direction of flight. Further, when the axis 20 of the image sensor 21 tilts upwards for 10° with respect to the roll axis 10 of the UAV 1, the upper vertical FOV of the image sensor 21 can be further increased by 10°. Therefore, the upper vertical FOV of the image sensor 21 can be increased to 40°. In this scenario, when the UAV 1 is horizontally flying at an attitude angle less than 40°, the object avoidance device 2 can effectively detect the object 9 in front of the direction of flight.

Therefore, according to the present disclosure, the axis 20 of the image sensor 21 is oblique with respect to the roll axis 10 of the UAV 1 and the width dimension of the image sensor 21 is smaller than the height dimension of the image sensor 21, such that when the UAV 1 is in the flight attitude, the FOV of the object avoidance device 2 can be further increased, which allows the UAV 1 to fly at a larger attitude angle, thereby improving the flight speed of the UAV 1.

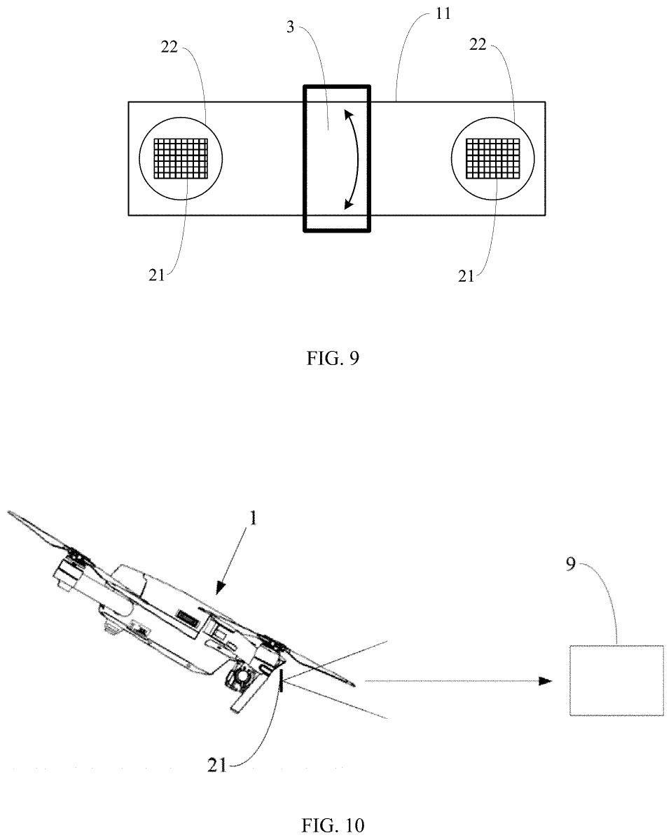

In some embodiments, as shown in FIG. 9, the UAV 1 further includes an adjusting device 3. The adjusting device 3 is coupled between the object avoidance device 2 and the UAV 1. The adjusting device 3 can adjust the inclination angle of the object avoidance device 2, i.e., the angle between the axis 20 of the image sensor 21 and the roll axis 10 of the UAV 1, such that when the UAV 1 is in the flight attitude, the object avoidance device 2 of the UAV 1 can detect an object in front of the UAV 1. In some embodiments, the adjusting device 3 includes a driving motor.

In some embodiments, the adjusting device 3 can adjust the object avoidance device 2 to rotate about a rotation axis perpendicular to the axis 20 of the image sensors 21, which can be also referred to as a pitch axis of the object avoidance device 2. The rotation axis is parallel to the pitch axis of the UAV 1. In some embodiments, the rotation axis of the object avoidance device 2, and the roll axis and the pitch axis of the UAV 1 are on a same plane. That is, the adjusting device 3 can adjust the object avoidance device 2 to rotate about the rotation axis perpendicular to the axis 20 of the image sensor 21, such that the axis 20 of the image sensor 21 is oblique with respect to the roll axis 10 of the UAV 1. As such, when the UAV 1 is flying forward, the pitch angle of the UAV 1 can be offset to a certain degree and the range of the FOV of the object avoidance device 2 can be increased. Therefore, when the UAV 1 is in the flight attitude, the object avoidance device 2 of the UAV 1 can detect an object in front of the UAV 1, which allows the UAV 1 to fly at a relative large attitude angle. The safety of the UAV 1 can be improved.

In some embodiments, the width dimension of the image sensor 21 is larger than the height dimension of the image sensor 21. The adjusting device 3 can adjust the object avoidance device 2 to rotate 90° about the axis 20 of the image sensor 21, such that the width dimension of the image sensor 21 becomes smaller than the height dimension of the image sensor after rotation, e.g., changing the image sensor 21 from the orientation shown in FIG. 9 to the orientation shown in FIG. 8. As such, when the UAV 1 is flying forward, the pitch angle of the UAV 1 can be offset to a certain degree and the range of the FOV of the object avoidance device 2 can be increased. Therefore, when the UAV 1 is in the flight attitude, the object avoidance device 2 of the UAV 1 can detect an object in front of the UAV 1, which allows the UAV 1 to fly at a relative large attitude angle. The safety of the UAV 1 can be improved.

In some embodiments, the width dimension of the image sensor 21 is larger than the height dimension of the image sensor. The adjusting device 3 can adjust the object avoidance device 2 to rotate about the rotation axis perpendicular to the axis 20 of the image sensor 21. The rotation axis is parallel to the pitch axis of the UAV 1. The adjusting device 3 can also adjust the object avoidance device 2 to rotate 90° about the axis 20 of the image sensor 21, such that the width dimension of the image sensor 21 becomes smaller than the height dimension of the image sensor 21 after rotation. Therefore, when the UAV 1 is in the flight attitude, the horizontal roll axis 10 can fall in the FOV of the object avoidance device. In some embodiments, the rotation axis of the object avoidance device 2, and the horizontal roll axis and the pitch axis of the UAV 1 are on a same plane. As such, when the UAV 1 is in the flight attitude, the range of the FOV of the object avoidance device 2 can be further increased, which allows the UAV 1 to fly at a larger attitude angle to further elevate the flight speed of the UAV 1.

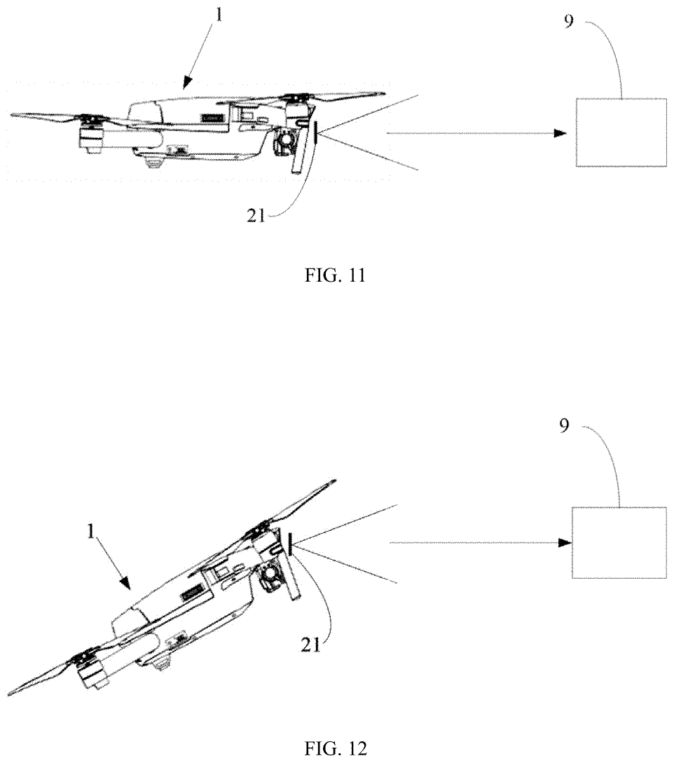

In some embodiments, the UAV 1 may further include a detection device. The detection device is configured to detect whether the object 9 in front of the UAV 1 falls in the FOV of the object avoidance device 2 when the pitch angle of the UAV 1 is greater than or equal to half of the vertical FOV of the object avoidance device 2. According to a detection result of the detection device, the adjusting device 3 can adjust the inclination angle of the object avoidance device 2, such that when the UAV 1 is in the flight attitude, the object avoidance device 2 of the UAV 1 can detect the object 9 in front of the UAV 1. As shown in FIGS. 10 to 12, when the UAV 1 is in the flight attitude, the adjusting device 3 can adjust the inclination angle of the object avoidance device 2 according to the detection result of the detection device, regardless of the attitude angle at which the UAV 1 is flying. As such, the image sensors 21 can be always directed to the direction of flight, which allows the object avoidance device 2 to work at the optimum angle and detect the object 9 in front of the UAV 1. That is, no matter how the object avoidance device 2 is mounted on the UAV 1, the adjusting device 3 can adjust the object avoidance device 2 to the position of the best FOV.

In some embodiments, the UAV 1 includes the object avoidance device 2 including the image sensor 21. The axis 20 of the image sensor 21 is parallel to the roll axis 10 of the UAV 1 and the width dimension of the image sensor 21 is smaller than the height dimension of the image sensor 21. As such, when the pitch angle of the UAV 1 is greater than or equal to half of the vertical FOV of the object avoidance device 2, the object 9 in front of the UAV 1 can still fall in the FOV of the object avoidance device 2. Therefore, when the UAV 1 is in the flight attitude, the object avoidance device 2 of the UAV 1 can detect an object 9 in front of the UAV 1, which allows the UAV 1 to fly at a relative large attitude angle. The safety of the UAV 1 can be improved.

The roll axis may refer to an axis through the body of the UAV (tail and nose) and parallel to the horizontal plane, or an axis in the direction of flight and parallel to the horizontal plane.

In some embodiments, the FOV of the object avoidance device 2 includes a horizontal FOV and a vertical FOV. When the pitch angle of the UAV 1 is greater than or equal to a half of the vertical FOV, the horizontal roll axis 10 still falls in the FOV of the object avoidance device 2.

In some embodiments, the axis 20 of the image sensor 21 is parallel to the roll axis 10 of the UAV 1 and the width dimension of the image sensor 21 is smaller than the height dimension of the image sensor 21, such that the range of the FOV of the object avoidance device 2 can be increased when the UAV 1 is in a flight attitude. Therefore, when the UAV 1 is in the flight attitude, the object avoidance device 2 of the UAV 1 can detect an object 9 in front of the UAV 1, which allows the UAV 1 to fly at a relative large attitude angle. The safety of the UAV 1 can be improved.

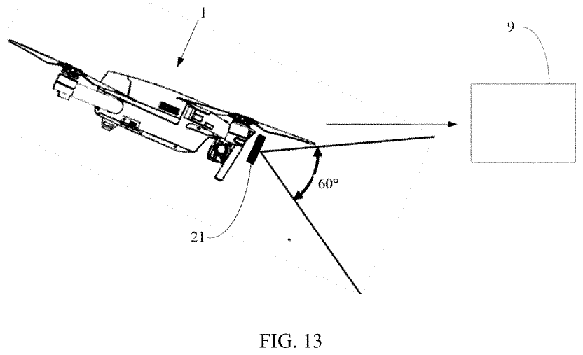

As shown in FIG. 13, for example, when the axis 20 of the image sensor 21 is parallel to the roll axis 10 of the UAV 1 and the width dimension of the image sensor 21 is smaller than the height dimension of the image sensor 21, the operation principle of the object avoidance device 2 of the UAV 1 will be described below. The image sensor 21 is provided on the front of the UAV 1, the axis 20 of the image sensor 21 is parallel to the roll axis 10 of the UAV 1, and the width dimension of the image sensor 21 is smaller than the height dimension of the image sensor 21.

Assume that for a UAV including an image sensor having a width dimension larger than a height dimension (such as shown in FIG. 3), the original horizontal FOV is 60° and the original vertical FOV is 45°, then for the image sensor having the width dimension smaller than the height dimension, the vertical FOV of the image sensor 21 is increased from the original 45° to 60°. When the UAV 1 is horizontally flying at an attitude angle less than 30°, the object avoidance device 2 can effectively detect the object 9 in front of the direction of flight. The upper vertical FOV of the image sensor 21 is increased by 7.5° from 22.5°.

Therefore, according to the disclosure, by setting the width dimension of the image sensor to be smaller than the height dimension of the image sensor, the range of the FOV of the object avoidance device can be increased when the UAV is in a flight attitude. Therefore, when the UAV is in the flight attitude, the object avoidance device of the UAV can detect an object in front of the UAV, which allows the UAV to fly at a relative large attitude angle. The flight speed of the UAV can be improved.

The terms “first,” “second,” or the like in the specification, claims, and the drawings of the present disclosure are merely used to distinguish similar elements, and are not intended to describe a specified order or a sequence. In addition, the terms “including,” “comprising,” and variations thereof herein are open, non-limiting terminologies, which are meant to encompass a series of steps of processes and methods, or a series of units of systems, apparatuses, or devices listed thereafter and equivalents thereof as well as additional steps of the processes and methods or units of the systems, apparatuses, or devices.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. An unmanned aerial vehicle (UAV) comprising:
a fuselage; and
an object avoidance device connected to the fuselage, the object avoidance device including an image sensor,
wherein an axis of the image sensor is oblique with respect to the fuselage.

2. The UAV according to claim 1, wherein a width dimension of the image sensor is smaller than a height dimension of the image sensor.

3. The UAV according to claim 1, wherein an angle between the axis of the image sensor and the fuselage is an acute angle.

4. The UAV according to claim 3, wherein the angle is in the range of 1° to 20°.

5. The UAV according to claim 1, further comprising:
an adjusting device coupled to the object avoidance device.

6. The UAV according to claim 5, wherein the adjusting device is configured to adjust the object avoidance device to rotate about a rotation axis perpendicular to the axis of the image sensor, the rotation axis being parallel to a pitch axis of the UAV.

7. The UAV according to claim 5, wherein the adjusting device is configured to adjust the object avoidance device to rotate 90° about the axis of the image sensor.

8. The UAV according to claim 5, further comprising:
a detection device configured to detect whether an object in front of the UAV falls in a field of view (FOV) of the object avoidance device when a pitch angle of the UAV is greater than or equal to one half of a vertical FOV of the object avoidance device.

9. The UAV according to claim 5, wherein the adjusting device includes a driving motor.

10. The UAV according to claim 1, further comprising:
a fuselage bracket,
wherein the object avoidance device is arranged on the fuselage bracket.

11. The UAV according to claim 10, wherein the fuselage bracket is provided on a front end of the UAV.

12. The UAV according to claim 1,
wherein the object avoidance device is a first object avoidance device provided on one side of the UAV,
the UAV further comprising:
a second object avoidance device provided on another side of the UAV.

13. The UAV according to claim 1, wherein the object avoidance device includes a lens, and the image sensor is arranged behind the lens.

14. The UAV according to claim 1, further comprising:
arms, propellers, and a camera arranged on the fuselage.

15. The UAV according to claim 1, wherein the UAV includes a multi-rotor aircraft.

16. An unmanned aerial vehicle (UAV) comprising:
a fuselage; and
an object avoidance device connected to the fuselage, the object avoidance device including an image sensor,
wherein:
an axis of the image sensor is parallel to the fuselage, and
a width dimension of the image sensor is smaller than a height dimension of the image sensor.
